(19) United States
(12) Patent Application Publication
(10) Pub. No.: US 2026/0280079 A1
(43) Pub. Date: Sep. 17, 2026

(54) CONDUCTIVE MODULE AND BATTERY PACK

(71) Applicant: YAZAKI CORPORATION, Tokyo (JP)

(72) Inventors: Mariko Nakagawa, Makinohara-shi (JP); Katsunori Sato, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/561,455

(22) Filed: Mar. 9, 2026

(30) Foreign Application Priority Data
Mar. 11, 2025 (JP) 2025-037946

(51) Int. Cl. H01M 50/583; H01M 50/209; H01M 50/249; B60L 50/64

(52) U.S. Cl. CPC H01M 50/583; H01M 50/209; H01M 50/249; B60L 50/64; H01M 2200/103; H01M 2220/20

(57) ABSTRACT

There are included a connection conductor that is directly electrically connected to an electrode terminal of a battery cell constituting a battery module, a fuse unit that indirectly electrically connects the connection conductor to a battery monitoring unit, and a housing component that is assembled to the battery module and in which the connection conductor and the fuse unit are housed, are provided, in which the housing component includes a housing member that is provided with a conductor housing chamber and a unit housing chamber, and a cover member that is assembled to the housing member and covers the conductor housing chamber and the unit housing chamber at an assembly completion position to the housing member, and the housing member also serves as a transport tray for transporting, to a next factory floor, at least either the connection conductor or the fuse unit in a housed state.

### CROSS-REFERENCE TO RELATED APPLICATION(S)

The present application claims priority to and incorporates by reference the entire contents of Japanese Patent Application No. 2025-037946 filed in Japan on March 11, 2025.

### BACKGROUND OF THE INVENTION

### Field of the Invention

The present invention relates to a conductive module and a battery pack.

### Description of the Related Art

A conductive module is assembled to a battery module in which a plurality of battery cells is arranged to constitute a battery pack together with the battery module. For example, in the battery module in which the plurality of battery cells is arranged, the conductive module electrically connects the plurality of battery cells by using a plurality of connection conductors. In addition, the conductive module electrically connects each of the connection conductors to a battery monitoring unit that monitors a battery state of each of the battery cells by using a wiring component such as an electric wire. For example, Japanese Patent Application Laid-open No. JP 2020 - 119 651 A described below discloses this type of conductive module. In some cases, the conductive module as described above is configured so that a combination of a pair of the connection conductor and conductor portion of the wiring component is provided for each of the connection conductors to interpose a circuit protection component, such as a fuse, between the connection conductor and the conductor portion of the wiring component in each combination. For example, Japanese Patent No. JP 7 561 318 B1 described below discloses a fuse unit (including a chip fuse, a pair of terminal fittings, and a wiring component) applied to this conductive module. After manufacture of the conductive module, the conductive module has a final product form in which the plurality of connection conductors and a plurality of the fuse units are housed in a housing component.

Incidentally, the conductive module is assembled to the final product form after components such as the connection conductors and the wiring components are gathered in one place, in some cases. In addition, in the conductive module, a subassembly (so-called semi-finished product) obtained by assembling two or more of the components is housed in a transport tray, the subassembly being housed in the transport tray is sent to another production factory or another factory floor, and components or another subassembly is assembled to the subassembly, in some cases. At this time, in the another production factory or on the another factory floor, the sent subassembly is taken out from the transport tray, the components or the another subassembly is assembled to the subassembly, and then, the assembled subassembly is housed in the previous or another transport tray. The conductive module is assembled into the final product form while repeating this process. The conductive module in the final product form is housed in the transport tray, and the final product form being housed in the transport tray is sent to another production factory. Then, the conductive module is taken out from the transport tray after transportation, and assembled to the battery module. In this way, the conductive module conventionally needs to be taken out from the transport tray, and taking the conductive module in and out of the transport tray is repeated, in some cases. In addition, the conductive module conventionally needs a plurality of types of transport trays as necessary in a transport process, in some cases. Therefore, the conductive modules conventionally have room for improvement, from the viewpoint of productivity.

### SUMMARY OF THE INVENTION

Therefore, an object of the present invention is to provide a conductive module and a battery pack that are configured to improve productivity.

In order to achieve the above mentioned object, a conductive module according to one aspect of the present invention includes a connection conductor that is directly electrically connected to an electrode terminal of a battery cell constituting a battery module; a fuse unit that indirectly electrically connects the connection conductor to a battery monitoring unit monitoring a battery state of the battery cell; and a housing component that is assembled to the battery module and in which the connection conductor and the fuse unit are housed, wherein the housing component includes a housing member that is provided with a conductor housing chamber housing the connection conductor and a unit housing chamber housing the fuse unit, and a cover member that is assembled to the housing member and covers the conductor housing chamber and the unit housing chamber at an assembly completion position to the housing member, and the housing member also serves as a transport tray for transporting, to a next factory floor, at least either the connection conductor or the fuse unit in a housed state.

In order to achieve the above mentioned object, a battery pack according to another aspect of the present invention includes a battery module in which a plurality of battery cells are arranged; a battery monitoring unit that monitors a battery state of each of the battery cells; and a conductive module that is assembled to the battery module, wherein the conductive module includes: a connection conductor that is directly electrically connected to an electrode terminal of the battery cell; a fuse unit that indirectly electrically connects the connection conductor to the battery monitoring unit; and a housing component that is assembled to the battery module and in which the connection conductor and the fuse unit are housed, the housing component includes a housing member that is provided with a conductor housing chamber housing the connection conductor and a unit housing chamber housing the fuse unit, and a cover member that is assembled to the housing member and covers the conductor housing chamber and the unit housing chamber at an assembly completion position to the housing member, and the housing member also serves as a transport tray for transporting, to a next factory floor, at least either the connection conductor or the fuse unit in a housed state.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is a schematic diagram illustrating a battery module together with a connection conductor;

FIG. 3 is a perspective view illustrating a fuse unit;

FIG. 4 is a perspective view illustrating the fuse unit (excluding a coating resin portion);

FIG. 5 is a plan view illustrating the conductive module according to an embodiment;

FIG. 6 is a perspective view illustrating an exemplary process of assembling the conductive module according to an embodiment; and

FIG. 7 is a perspective view illustrating an exemplary process of assembling the conductive module according to an embodiment.

### DETAILED DESCRIPTION OF THE PREFERRED EMBODIMENTS

Hereinafter, embodiments of a conductive module and a battery pack according to the present invention will be described in detail with reference to the drawings. It should be noted the present invention is not limited to the embodiments.

### Embodiments

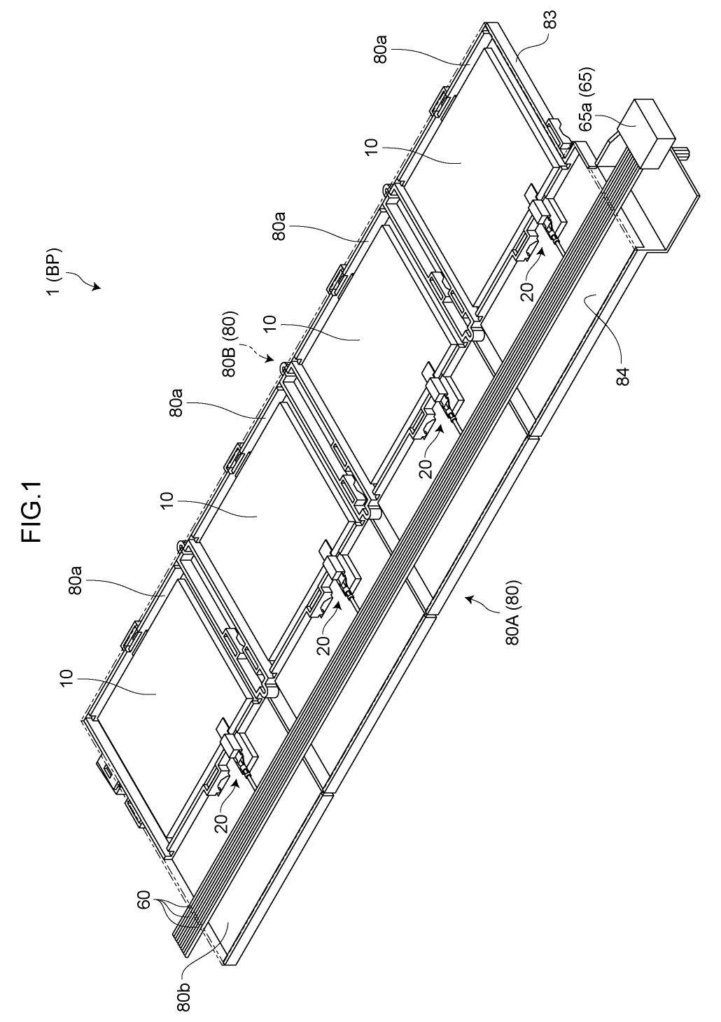

One of the embodiments of the conductive module and the battery pack according to the present invention will be described with reference to FIGS. 1 to 7.

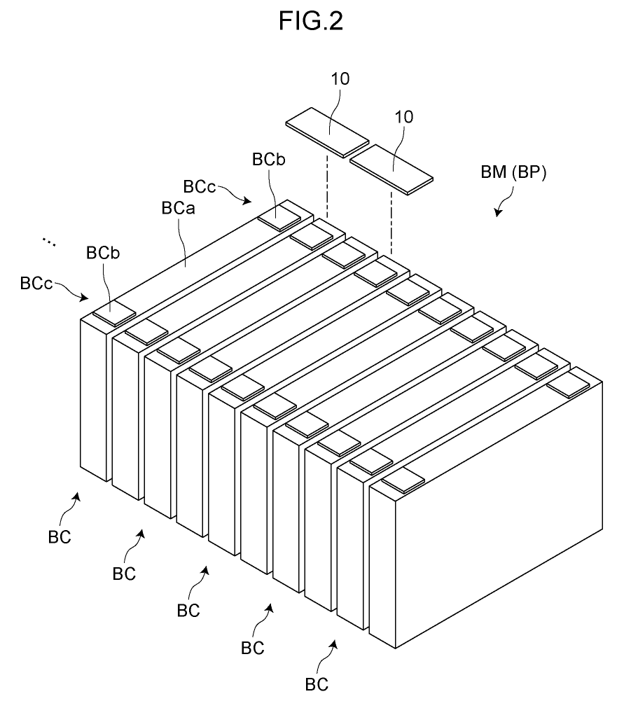

Reference numeral 1 in FIG. 1 denotes the conductive module of the present embodiment. The conductive module 1 is assembled to a battery module BM (FIG. 2) in which a plurality of battery cells BC is arranged, and electrically connects the plurality of battery cells BC in the battery module BM. Furthermore, the conductive module 1 electrically connects the battery module BM to a battery monitoring unit (not illustrated) to cause the battery monitoring unit to monitor a battery state of each of the battery cells BC. The conductive module 1 constitutes a battery pack BP together with the battery module BM and the battery monitoring unit. The battery pack BP is mounted on, for example, a vehicle (battery electric vehicle (BEV), hybrid electric vehicle (HEV), etc.) including a motor as a drive source, and is used for power supply or the like to the motor.

Each of the battery cells BC includes a cell body BCa and positive and negative electrode terminals BCb (FIG. 2). In the battery module BM, the plurality of battery cells BC is arranged in a row in an arrangement direction. The battery module BM includes one electrode terminal group BCc in which one electrode terminal BCb of each of the plurality of battery cells BC is arranged in the arrangement direction, and the other electrode terminal group BCc in which the other electrode terminals BCb of the plurality of battery cells BC are arranged in the arrangement direction (FIG. 2).

Hereinafter, description "arrangement direction" used when not particularly specified refers to an arrangement direction of the plurality of battery cells BC and an arrangement direction of a plurality of the electrode terminals BCb in an electrode terminal group BCc.

In each of the battery cells BC described here, the cell body BCa is formed in a parallelepiped shape having six outer wall surfaces. In the plurality of battery cells BC, cell bodies BCa adjacent to each other in the arrangement direction are arranged with one outer wall surface facing each other. For example, in each battery cell BC, the positive and negative electrode terminals BCb are arranged on one of the six outer wall surfaces of the cell body BCa or are arranged separately on two of the six outer wall surfaces of the cell body BCa. In this example, each battery cell BC includes the positive and negative electrode terminals BCb each arranged on one of the six outer wall surfaces of the cell body BCa (FIG. 2). Therefore, in the battery module BM, two electrode terminal groups BCc are provided on one plane (FIG. 2).

The electrode terminal BCb described here is formed into a flat plate shape, and a connection conductor 10 which is described later is directly electrically connected to the electrode terminal BCb by laser welding or the like (FIG. 2). However, the electrode terminal BCb may be formed in an electrode post shape having a male thread portion. In this case, the connection conductor 10 is fixedly screwed to the electrode terminal BCb by threadedly engaging a female thread member with the male thread portion of the electrode terminal BCb.

The conductive module 1 includes the connection conductors 10 that are directly electrically connected to the electrode terminals BCb of the battery cells BC constituting the battery module BM (FIGS. 1 to 4).

The connection conductors 10 are each formed of a metal material. The connection conductor 10 is a plate-shaped conductive component made of metal, called bus bar, and is obtained by press-molding, for example, a metal plate as a base material. The connection conductor 10 described here is formed in a rectangular flat plate shape.

The conductive module 1 includes, for example, the connection conductor 10 that is directly electrically connected to adjacent electrode terminals BCb of a pair of the battery cells BC in the battery module BM, the connection conductor 10 that is directly electrically connected to an electrode terminal BCb serving as a total negative electrode in the battery module BM, and the connection conductor 10 that is directly electrically connected to an electrode terminal BCb serving as a total positive electrode in the battery module BM.

The conductive module 1 includes a fuse unit 20 that indirectly electrically connects each connection conductor 10 to the battery monitoring unit (FIGS. 1, 3, and 4). The fuse unit 20 indirectly electrically connects the connection conductor 10 and the battery monitoring unit, and interrupts energization when an overcurrent flows therebetween. The fuse unit 20 is provided for each connection conductor 10.

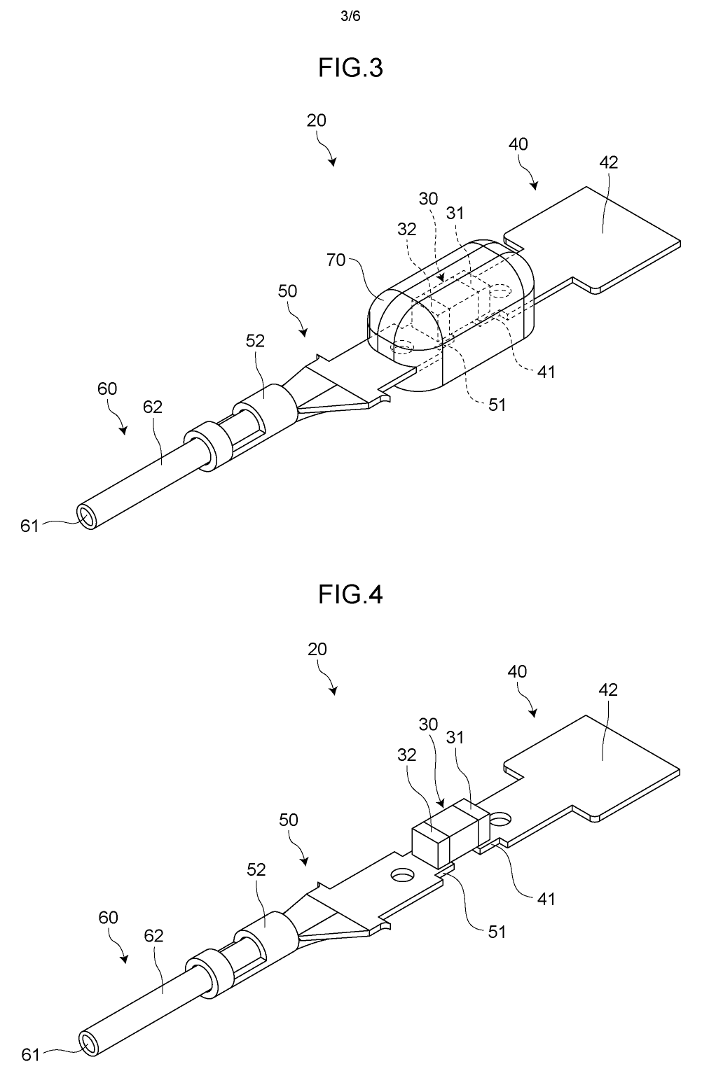

The fuse unit 20 includes a circuit protection component 30 that melts a fusible portion when an overcurrent flows between the connection conductor 10 and the battery monitoring unit (FIGS. 3 and 4). The circuit protection component 30 includes a first electrode 31 and a second electrode 32 that are arranged across the fusible portion (FIGS. 3 and 4). The first electrode 31 and the second electrode 32 are arranged on a straight line so as to be separated from each other at one end and the other end of the circuit protection component 30.

The circuit protection component 30 may be configured as, for example, a chip fuse having the fusible portion, or may be configured as a pattern fuse in which a wiring pattern having the fusible portion is provided on a printed circuit board (e.g., flexible printed circuit board). The circuit protection component 30 described here is configured as the chip fuse of parallelepiped shape. The first electrode 31 is provided at one end of the circuit protection component 30, over five outer wall surfaces. The second electrode 32 is provided at the other end of the circuit protection component 30 over five outer wall surfaces.

The fuse unit 20 includes a first terminal fitting 40 and a second terminal fitting 50 that are directly electrically connected to the circuit protection component 30 (FIGS. 3 and 4). The first terminal fitting 40 and the second terminal fitting 50 are formed of a conductive material such as a metal. For example, the first terminal fitting 40 and the second terminal fitting 50 are each obtained by press-molding a metal plate as a base material.

The first terminal fitting 40 includes a first electrical connection portion 41 that is directly electrically connected to the first electrode 31 of the circuit protection component 30 (FIGS. 3 and 4). One of four outer wall surfaces of the first electrode 31 arranged in a circumferential direction is placed on the first electrical connection portion 41, and the first electrode 31 is directly electrically connected thereto by laser welding, soldering, or the like. Therefore, the first electrical connection portion 41 is formed in a flat plate shape provided with a flat surface on which the outer wall surface of the first electrode 31 is placed. In the first electrical connection portion 41, the flat surface and the first electrode 31 are directly electrically connected (FIGS. 3 and 4).

Furthermore, the first terminal fitting 40 includes a conductor connection portion 42 that is electrically connected directly or indirectly to the connection conductor 10 (FIGS. 3 and 4). The conductor connection portion 42 is formed into a flat plate shape, and is placed on the connection conductor 10 with flat surfaces of both overlapping each other. Then the conductor connection portion 42 is directly electrically connected to the connection conductor 10 by laser welding, ultrasonic bonding, or the like. The conductor connection portion 42 described here is formed in a rectangular flat plate shape.

The first terminal fitting 40 described here is formed in a single flat plate shape in which the first electrical connection portion 41 and the conductor connection portion 42 are adjacent to each other.

The second terminal fitting 50 includes a second electrical connection portion 51 that is directly electrically connected to the second electrode 32 of the circuit protection component 30 (FIGS. 3 and 4). One of four outer wall surfaces of the second electrode 32 arranged in a circumferential direction is placed on the second electrical connection portion 51, and the second electrode 32 is directly electrically connected by laser welding, soldering, or the like. Therefore, the second electrical connection portion 51 is formed in a flat plate shape provided with a flat surface on which the outer wall surface of the second electrode 32 is placed. In the second electrical connection portion 51, the flat surface and the second electrode 32 are directly electrically connected (FIGS. 3 and 4).

Furthermore, the second terminal fitting 50 is indirectly electrically connected to the battery monitoring unit. The fuse unit 20 includes a wiring component 60 interposed between the second terminal fitting 50 and the battery monitoring unit (FIGS. 1, 3, and 4), and indirectly electrically connects the second terminal fitting 50 to the battery monitoring unit via the wiring component 60. The second terminal fitting 50 includes a wire connection portion 52 that is directly electrically connected to the wiring component 60 (FIGS. 3 and 4).

The wiring component 60 includes a conductor portion 61 that has one end directly electrically connected to the second terminal fitting 50, and the other end indirectly electrically connected to the battery monitoring unit (FIGS. 3 and 4). Then, at an end of the wiring component 60, insulation coating 62 with electrical insulation property is provided that covers the conductor portion 61 on a side closer to the battery monitoring unit than to at least one end (FIGS. 3 and 4). The wiring component 60 described here is a linear conductor having the conductor portion 61 formed in a linear shape. Specifically, the wiring component 60 is an electric wire in which a core wire as the conductor portion 61 is covered with the insulation coating 62 having the electrical insulation property, and the wire connection portion 52 is directly electrically connected to the one end of the conductor portion 61 at the end of the wiring component 60.

For example, at the end of the wiring component 60, the insulation coating 62 is peeled off to expose the one end of the conductor portion 61. In this configuration, it is sufficient to apply the wire connection portion 52 in which a swage/crimp portion to be swaged and crimped at the one end (i.e., the core wire at the end of the electric wire) of the conductor portion 61 is formed. In addition, for example, the wiring component 60 having the end at which the conductor portion 61 is covered with the insulation coating 62 up to the one end may be used. In this configuration, it is sufficient to apply the wire connection portion 52 that is formed as a pair of press-contact blades making a cut in the insulation coating 62 at the end of the wiring component 60 to hold the one end of the conductor portion 61 (the core wire at the end of the electric wire). The wire connection portion 52 described here is formed as the swage/crimp portion.

In the second terminal fitting 50 described here, the second electrical connection portion 51 and the wire connection portion 52 are adjacent to each other. The wire connection portion 52 leads out the wiring component 60 in a direction in which the second electrical connection portion 51 and the wire connection portion 52 are adjacent to each other and in a direction along the flat surface of the second electrical connection portion 51.

Note that the wiring component 60 may be a flat wiring member such as a flexible printed circuit board on which the conductor portion 61 is formed as a wiring pattern (not illustrated). In this configuration, in the wiring component 60, the conductor portion 61 is formed for each of the second terminal fittings 50 in a plurality of the fuse units 20, and one end of the conductor portion 61 is provided at an end of a branched portion branched from a main body for each of the second terminal fittings 50. The one end of the conductor portion 61 is directly electrically connected to the wire connection portion 52 by, for example, laser welding, soldering, or the like.

The fuse units 20 include a connector 65 that is assembled to the wiring components 60 and is fitted and connected to a mating connector of the battery monitoring unit to indirectly electrically connect the wiring components 60 to the battery monitoring unit (FIG. 1). For example, the wiring component 60 (electric wire) of each of the fuse units 20 is routed toward the battery monitoring unit side, and an end of the wiring component 60 routed toward the battery monitoring unit side is connected to the connector 65. In the connector 65, the conductor portion 61 at the end of each wiring component 60 (electric wire) is housed in a connector housing 65a.

The fuse unit 20 includes a coating resin portion 70 having an electrical insulation property that seals the first electrical connection portion 41, the second electrical connection portion 51, and the circuit protection component 30 (FIGS. 3 and 4). The coating resin portion 70 seals the first electrical connection portion 41, the second electrical connection portion 51, and the circuit protection component 30 to suppress energization between the first electrical connection portion 41 and the second electrical connection portion 51. The coating resin portion 70 enables suppression of, for example, a short circuit between the first electrical connection portion 41 and the second electrical connection portion 51 due to dew condensation water. For example, the coating resin portion 70 is obtained by solidifying a liquid resin material (so-called ultraviolet curable or thermosetting potting material), the liquid resin material being supplied by dropping or the like and sealing the first electrical connection portion 41, the second electrical connection portion 51, and the circuit protection component 30.

The conductive module 1 of the present embodiment includes a housing component (hereinafter, referred to as "module housing component") 80 that is assembled to the battery module BM and in which the connection conductors 10 and the fuse unit 20 are housed (FIG. 1).

The module housing component 80 is provided with a housing chamber (hereinafter, referred to as "conductor housing chamber") 80a that houses the connection conductor 10 and a housing chamber (hereinafter referred to as "unit housing chamber") 80b that houses the fuse unit 20 (FIG. 1). For example, the module housing component 80 includes the conductor housing chamber 80a for each connection conductor 10 connected to each electrode terminal BCb of the electrode terminal group BCc. Meanwhile, the module housing component 80 includes the unit housing chamber 80b in which the fuse units 20 for the respective connection conductors 10 are collectively housed.

When the wiring component 60 is an electric wire, in the unit housing chamber 80b, the wiring component 60 (electric wire) of each fuse unit 20 is routed toward the battery monitoring unit, and the connector 65 is arranged at a destination of the routing (FIG. 1). Furthermore, when the wiring component 60 is a flat wiring member, the unit housing chamber 80b houses the wiring component 60 (flat wiring member) in which the connector 65 is assembled to an end near the battery monitoring unit (not illustrated).

For example, the module housing component 80 includes a first housing member (hereinafter, referred to as "first module housing member") 80A and a second housing member (hereinafter, referred to as "second module housing member") 80B that are assembled and fixed to each other (FIG. 1). The first module housing member 80A and the second module housing member 80B are each formed of an electrically insulating material such as a synthetic resin.

The first module housing member 80A is provided with the conductor housing chamber 80a and the unit housing chamber 80b. Therefore, the first module housing member 80A is provided with space portions for forming a plurality of the conductor housing chambers 80a and the unit housing chamber 80b at an assembly completion position to the second module housing member 80B. The second module housing member 80B is a cover member that covers the conductor housing chambers 80a and the unit housing chamber 80b at the assembly completion position to the first module housing member 80A. Therefore, the second module housing member 80B is molded so as to be able to close openings of the space portions of the first module housing member 80A.

Here, the first module housing member 80A also serves as a transport tray for transporting, to a next factory floor, at least either the connection conductors 10 or the fuse unit 20 in a housed state.

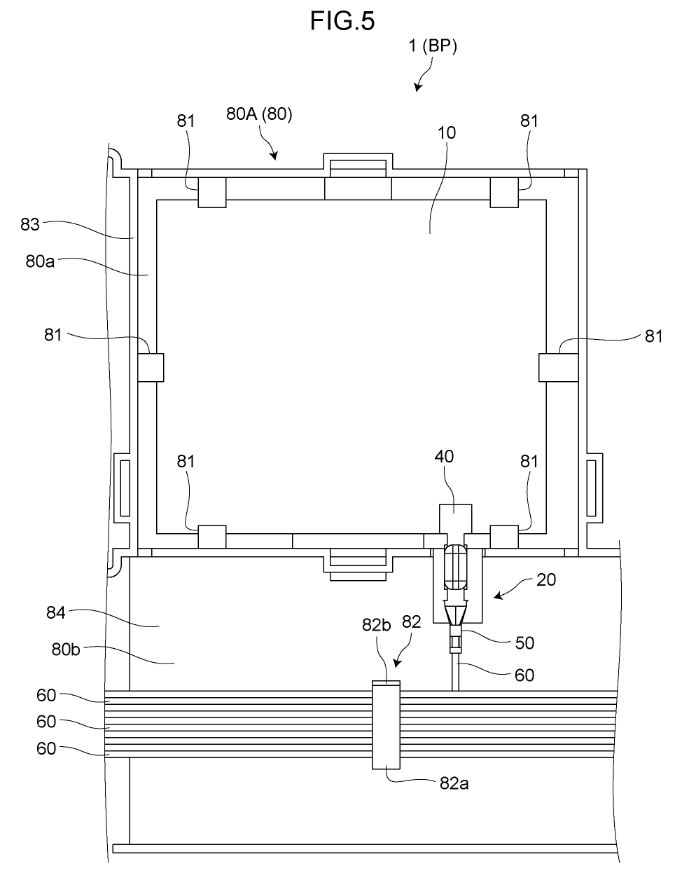

Therefore, the first module housing member 80A is provided with a conductor holding portion 81 that holds the connection conductor 10 in the housing chamber 80a and a unit holding portion 82 that holds the fuse unit 20 in the unit housing chamber 80b (FIG. 5).

For example, in the first module housing member 80A, the inside of a rectangular frame portion 83 is used as the conductor housing chamber 80a (FIGS. 1 and 5). Therefore, in the first module housing member 80A, the conductor holding portions 81 are preferably protruded from a plurality of positions in the frame portion 83. For example, at least one conductor holding portion 81 is protruded from each of four wall portions forming the frame portion 83 (FIG. 5). For example, the connection conductor 10 has an outer peripheral edge portion whose end surfaces are held by the conductor holding portions 81 provided at the plurality of positions and each having a rib shape. In addition, the conductor holding portion 81 may be a flexible piece portion having an end provided with a claw so that the claw is hooked on the outer peripheral edge portion of the connection conductor 10 to hold the connection conductor 10 in the conductor housing chamber 80a.

Furthermore, the unit housing chamber 80b includes a bottom wall 84 between the fuse unit 20 and the battery cell BC (FIGS. 1 and 5). Therefore, in the first module housing member 80A, the unit holding portion 82 is preferably protruded from the bottom wall 84. The bottom wall 84 is provided with the unit holding portions 82 at a plurality of positions, causing the plurality of the unit holding portions 82 to hold the wiring components 60 (electric wires) of the respective fuse units 20. For example, the unit holding portion 82 includes a piece portion 82a that covers the wiring components 60 (electric wires) with the bottom wall 84, and a living hinge 82b that opens and closes the piece portion 82a relative to the bottom wall 84, and covers and holds the wiring components 60 (electric wires) with the piece portion 82a at a closed position (FIG. 5). Note that the piece portion 82a at the closed position is held on the bottom wall 84 by a lock mechanism (not illustrated) including a claw or the like.

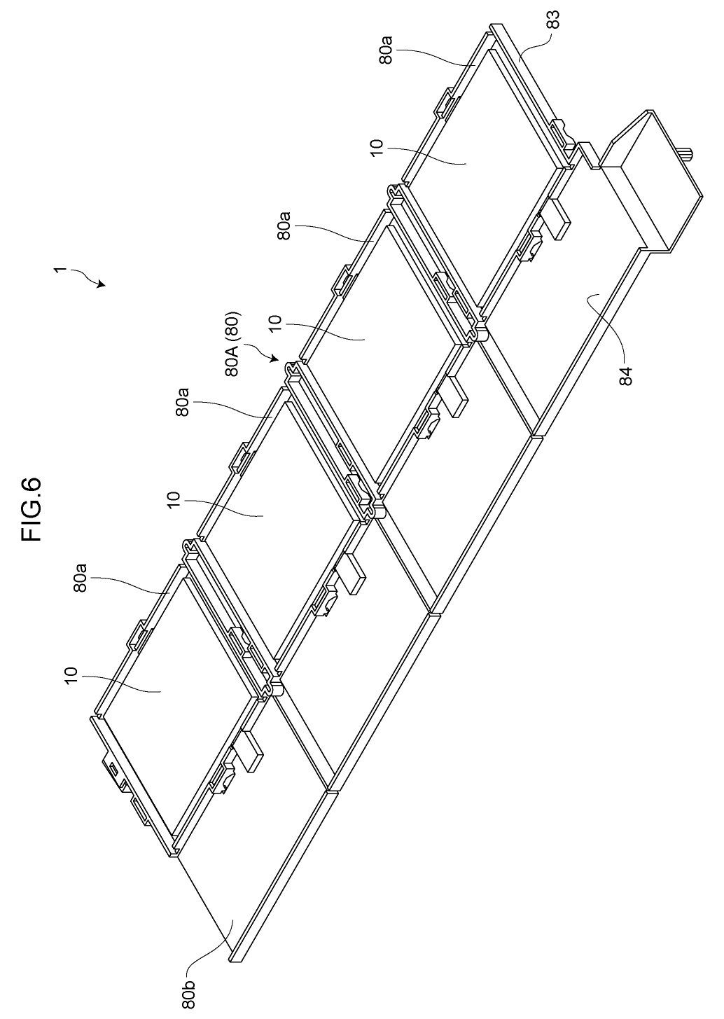

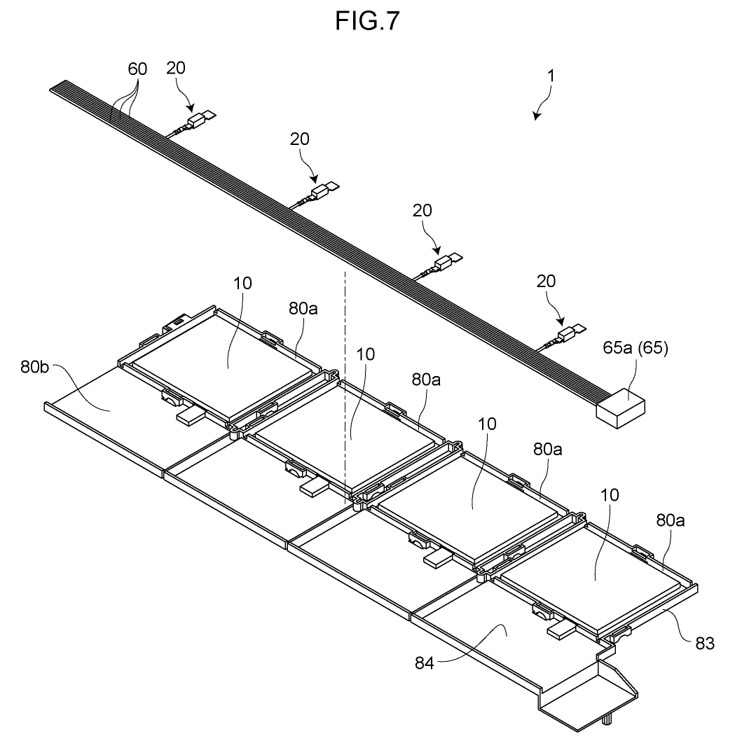

For example, in the conductive module 1, the connection conductors 10, the circuit protection components 30, the first terminal fittings 40, the second terminal fittings 50, the wiring components 60, the connector 65, and the first module housing member 80A are gathered on a first factory floor. On the first factory floor, the connection conductors 10 are housed in the conductor housing chambers 80a of the first module housing member 80A, and the connection conductors 10 are held by the conductor holding portions 81 (FIG. 6, where the conductor holding portions 81 are not illustrated). On the first factory floor, the circuit protection components 30, the first terminal fittings 40, the second terminal fittings 50, the wiring components 60, and the connector 65 are assembled to each other to manufacture the fuse units 20. Then, on the first factory floor, the fuse units 20 are housed in the unit housing chamber 80b of the first module housing member 80A, and the fuse units 20 are held by the unit holding portions 82 (FIG. 7, where the unit holding portions 82 are not illustrated). Thereafter, the connection conductors 10 and the first terminal fittings 40 are connected on the first factory floor (FIG. 1). The first module housing member 80A also serves as the transport tray, and therefore, the conductive module 1 is housed as it is in a tray housing member (not illustrated) and transported to a next second factory floor (may be another workplace in the same production factory, or may be another production factory). Here, the conductive module 1 is sent to the second factory floor on which the conductive module 1 and the battery module BM are assembled, and the conductive module 1 taken out from the tray housing member is assembled to the battery module BM to manufacture the battery pack BP.

Note that the second module housing member (cover member) 80B is, for example, temporarily held by the first module housing member 80A on the first factory floor, and is sent to the second factory floor together with the first module housing member 80A and the like.

Furthermore, for example, in the conductive module 1, the connection conductors 10 are housed in the conductor housing chambers 80a of the first module housing member 80A, on the first factory floor at first, and the connection conductors 10 are held by the conductor holding portions 81 (FIG. 6, where the conductor holding portions 81 are not illustrated). The first module housing member 80A also serves as the transport tray, and therefore, this semi-finished product in which the connection conductors 10 and the first module housing member 80A are assembled is housed as it is in the tray housing member (not illustrated) and transported to the next second factory floor (may be another workplace in the same production factory, or may be another production factory). On the second factory floor, the fuse units 20 have been manufactured by assembling the circuit protection components 30, the first terminal fittings 40, the second terminal fittings 50, the wiring components 60, and the connector 65 to each other. On this second factory floor, the fuse units 20 are housed in the unit housing chamber 80b of the first module housing member 80A that is the semi-finished product taken out from the tray housing member, and the fuse units 20 are held by the unit holding portions 82 (FIG. 7, where the unit holding portions 82 are not illustrated). Thereafter, the connection conductors 10 and the first terminal fittings 40 are connected on the second factory floor (FIG. 1). The first module housing member 80A also serves as the transport tray, and therefore, the conductive module 1 is returned as it is to the tray housing member and transported to a next third factory floor (may be another workplace in the same production factory, or may be another production factory). Here, the conductive module 1 is sent to the third factory floor on which the conductive module 1 and the battery module BM are assembled, and the conductive module 1 taken out from the tray housing member is assembled to the battery module BM to manufacture the battery pack BP.

Note that the second module housing member (cover member) 80B is temporarily held by the first module housing member 80A, for example, on the second factory floor, and is sent to the third factory floor together with the first module housing member 80A and the like.

In this way, in the conductive module 1 of the present embodiment, the first module housing member 80A also serves as the transport tray, and therefore, it is unnecessary to prepare the transport tray used only for transport between the factory floors. Accordingly, this configuration eliminates the need for storing the semi-finished product or the final product in the transport tray or taking out the semi-finished product from the transport tray, in the conductive module 1 of the present embodiment. In other words, the conductive module 1 of the present embodiment does not require taking the semi-finished product in and out of the transport tray. In addition, in the conductive module 1 of the present embodiment, it is unnecessary to prepare the transport trays for transport between the factory floors, as dedicated products having different shapes, for example, for the respective semi-finished products, and therefore, it is unnecessary to prepare the tray housing members that house the transport trays upon transport between the factory floors, as dedicated products having different shapes for the respective transport trays. In other words, in the conductive module 1 of the present embodiment, it is sufficient to prepare one type of tray housing member corresponding to one type of first module housing member 80A also serving as the transport tray. From the above, in the conductive module 1 of the present embodiment, it is unnecessary to manage the transport trays as the dedicated products, management of the one type of tray housing member according to the first module housing member 80A is only required, and therefore, productivity is improved, leading to reduced cost.

The battery pack BP of the present embodiment includes the conductive module 1, and can have the similar effects to those obtained by the conductive module 1.

In the conductive module according to the present embodiment, the housing member also serves as the transport tray, and therefore, it is unnecessary to prepare the transport tray used only for transport between the factory floors. Accordingly, this configuration eliminates the need for storing the semi-finished product or the final product in the transport tray or taking out the semi-finished product from the transport tray, in the conductive module according to the present embodiment. In other words, the conductive module according to the present embodiment does not require taking the semi-finished product in and out of the transport tray. In addition, in the conductive module according to the present embodiment, it is unnecessary to prepare the transport trays for transport between factory floors, as dedicated products having different shapes, for example, for the respective semi-finished products, and therefore, it is unnecessary to prepare tray housing members that house the transport trays upon transport between the factory floors, as dedicated products having different shapes for the respective transport trays. In other words, in the conductive module according to the present embodiment, it is sufficient to prepare one type of tray housing member corresponding to one type of the housing member that also serves as the transport tray. As described above, in the conductive module according to the present embodiment, it is unnecessary to manage the transport trays as the dedicated products, management of the one type of tray housing member according to the housing member is only required, and therefore, productivity is improved, leading to reduced cost. The battery pack according to the present embodiment includes the conductive module, and can have the similar effects to those obtained by the conductive module.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a connection conductor that is directly electrically connected to an electrode terminal of a battery cell constituting a battery module;
a fuse unit that indirectly electrically connects the connection conductor to a battery monitoring unit monitoring a battery state of the battery cell; and
a housing component that is assembled to the battery module and in which the connection conductor and the fuse unit are housed, wherein
the housing component includes a housing member that is provided with a conductor housing chamber housing the connection conductor and a unit housing chamber housing the fuse unit, and a cover member that is assembled to the housing member and covers the conductor housing chamber and the unit housing chamber at an assembly completion position to the housing member, and
the housing member also serves as a transport tray for transporting, to a next factory floor, at least either the connection conductor or the fuse unit in a housed state.

2. The conductive module according to claim 1, wherein
the housing member includes a conductor holding portion that holds the connection conductor in the conductor housing chamber, and a unit holding portion that holds the fuse unit in the unit housing chamber.

3. The conductive module according to claim 1, wherein
the fuse unit includes:
a circuit protection component that melts a fusible portion when an overcurrent flows between the connection conductor and the battery monitoring unit;
a first terminal fitting that directly electrically connects a first electrical connection portion to a first electrode of the circuit protection component, and is directly or indirectly electrically connected to the connection conductor;
a second terminal fitting that directly electrically connects a second electrical connection portion to a second electrode of the circuit protection component, and is indirectly electrically connected to the battery monitoring unit;
a wiring component that includes a conductor portion having one end directly electrically connected to the second terminal fitting, and the other end indirectly electrically connected to the battery monitoring unit; and
a connector that is assembled to the wiring component and is fitted and connected to a mating connector of the battery monitoring unit to indirectly electrically connect the wiring component to the battery monitoring unit.

4. The conductive module according to claim 2, wherein
the fuse unit includes:
a circuit protection component that melts a fusible portion when an overcurrent flows between the connection conductor and the battery monitoring unit;
a first terminal fitting that directly electrically connects a first electrical connection portion to a first electrode of the circuit protection component, and is directly or indirectly electrically connected to the connection conductor;
a second terminal fitting that directly electrically connects a second electrical connection portion to a second electrode of the circuit protection component, and is indirectly electrically connected to the battery monitoring unit;
a wiring component that includes a conductor portion having one end directly electrically connected to the second terminal fitting, and the other end indirectly electrically connected to the battery monitoring unit; and
a connector that is assembled to the wiring component and is fitted and connected to a mating connector of the battery monitoring unit to indirectly electrically connect the wiring component to the battery monitoring unit.

5. A battery pack comprising:
a battery module in which a plurality of battery cells are arranged;
a battery monitoring unit that monitors a battery state of each of the battery cells; and
a conductive module that is assembled to the battery module, wherein
the conductive module includes:
a connection conductor that is directly electrically connected to an electrode terminal of the battery cell;
a fuse unit that indirectly electrically connects the connection conductor to the battery monitoring unit; and
a housing component that is assembled to the battery module and in which the connection conductor and the fuse unit are housed,
the housing component includes a housing member that is provided with a conductor housing chamber housing the connection conductor and a unit housing chamber housing the fuse unit, and a cover member that is assembled to the housing member and covers the conductor housing chamber and the unit housing chamber at an assembly completion position to the housing member, and
the housing member also serves as a transport tray for transporting, to a next factory floor, at least either the connection conductor or the fuse unit in a housed state.
